(19) United States
(12) Patent Application Publication
(10) Pub. No.: US 2014/0211065 A1
(43) Pub. Date: Jul. 31, 2014

(54) METHOD AND SYSTEM FOR CREATING A CONTEXT BASED CAMERA COLLAGE

(71) Applicant: Samsung Electronics Co., Ltd., Suwon-si (KR)

(72) Inventors: Pavan SUDHEENDRA, Bangalore (IN); Sumanta BARUAH, Bangalore (IN); Yogesh MANAV, Bangalore (IN); Rajaram NAGANUR, Hubli (IN)

(73) Assignee: Samsung Electronics Co., Ltd., Suwon-si (KR)

(21) Appl. No.: 14/167,452

(22) Filed: Jan. 29, 2014

(30) Foreign Application Priority Data
Jan. 30, 2013 (IN) 395/CHE/2013

(51) Int. Cl. H04N 5/232

(52) U.S. Cl. CPC H04N 5/23293
USPC 348/333.02

(57) ABSTRACT

A method and a system for creating a context based dynamic collage while capturing images are provided. The method facilitates a user to create an image collage while capturing images. Each snapshot captured by the user shall be added sequentially to the collage based upon the context. In a case where the context changes, a snapshot will be added to the new context collage. The user can have an option to view the collages being created in real time.

### CROSS-REFERENCE TO RELATED APPLICATION(S)

This application claims the benefit under 35 U.S.C. §119(a) of an Indian patent application filed on Jan. 30, 2013 in the Indian Patent Office and assigned Serial number 395/CHE/2013, the entire disclosure of which is hereby incorporated by reference.

### TECHNICAL FIELD

The present disclosure relates to image processing. More particularly, the present disclosure relates to a method and a system for creating a collage in real time while capturing images.

### BACKGROUND

Digitization has helped the growth of consumer electronics products, the digital cameras are one of the beneficiaries of this technological advancement. The digital camera industry has seen unprecedented growth in the recent past and they hold immense potential with ease of their usage, digitization, major innovations, and diversity in product concepts, declining prices, and growth in emerging markets.

The other factor to be taken into account is the tremendous sales of cell phones with built in digital cameras, while latest trends show cameras developed in Android Operating System (OS). These factors have enhanced the opportunities for taking pictures and reduced the effort and expense of photography where users are now accumulating huge collections of digital images. As a result, there had been a reduction of cost, effort, and convenience thresholds to capture digital images and to access important images within these collections. This has become increasingly difficult due to the sheer volume of content.

A user may be able to summarize an event or an image collection by creating an arrangement of images. This arrangement of images is referred to as a collage and sometimes the resulting composite image is photographed so that a final image may appear as a seamless photographic print. Digital collage is the technique of using computer tools in collage creation to encourage chance associations of disparate visual elements and the subsequent transformation of the visual results through the use of electronic media.

Collage applications of the related art allow the user to create the image collage from the set of previously existing images. Some techniques include capturing sequence of images and processing them on a computer. This technique is not convenient because it requires capturing several images and needs sophisticated software for post-processing. Further, automatic stitching programs available in the market do not properly facilitate managing different objects in the stitched images. Further, there is no real time application to create a collage in real time.

Due to the above mentioned reasons, the system of the related art fails to provide a solution to the user to create a collage in real time while capturing images.

Therefore, a need exists for a method and a system for creating a collage in real time while capturing images.

The above information is presented as background information only to assist with an understanding of the present disclosure. No determination has been made, and no assertion is made, as to whether any of the above might be applicable as prior art with regard to the present disclosure

### SUMMARY

Aspects of the present disclosure are to address at least the above-mentioned problems and/or disadvantages and to provide at least the advantages described below. Accordingly, an aspect of the present disclosure is to provide a method and a system for creating a collage in real time while capturing images.

Another aspect of the present disclosure is to provide a method and a system for creating a collage based on context information, such as time, geo-location, image content, and the like.

In accordance with another aspect of the present disclosure, a method for creating a context based collage dynamically while capturing images in a camera is provided. The method includes selecting the images to create the collage by a user. Further the method invokes a User Interface (UI) to obtain an input from the user and extracts a Region of Interest (ROI) for the images. Finally the method creates the collage using the captured images based on a context criterion.

In accordance with another aspect of the present disclosure a system for creating a context based collage dynamically while capturing images in a camera is provided. The system includes a device file module, a remote content server module, a UI module, a display module, a camera module, and a collage module. The system also includes an integrated circuit. Further the integrated circuit includes at least one processor and at least one memory. The memory includes a computer program code within the circuit. At least one memory and the computer program code with at least one processor cause the system to select the images to create the collage by a user using the UI module. Further the system is configured to invoke a UI to obtain an input from the user using the UI module. Thereafter, the system is configured to extract an ROI for the images using the camera module. Further, the system is configured to create the collage using the collage module based on a context criterion.

In accordance with another aspect of the present disclosure, a device for creating a context based collage dynamically while capturing images in a camera is provided. The device includes an integrated circuit. Further the integrated circuit includes at least one processor and at least one memory. The memory includes a computer program code within the circuit. The at least one memory and the computer program code with the at least one processor cause the device to select the images to create the collage by a user. Further the device is configured to invoke a UI to obtain an input from the user. Thereafter, the device is further configured to extract an ROI for the images. Moreover, the system is configured to create the collage based on the number of captured images.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTIONOF THE DRAWINGS

The above and other aspects, features, and advantages of certain embodiments of the present disclosure will be more apparent from the following description taken in conjunction with the accompanying drawings, in which:

FIG. 1 illustrates a block diagram of a collage system according to an embodiment of the present disclosure;

FIG. 2 is a block diagram illustrating components of a collage module according to an embodiment of the present disclosure;

FIG. 3 is a block diagram illustrating a camera collage user interaction according to an embodiment of the present disclosure;

FIG. 4 is a block diagram illustrating a real time collage frame preview along with a latest collage according to an embodiment of the present disclosure;

FIG. 5 is a block diagram illustrating a viewfinder along with a real time collage frame preview according to an embodiment of the present disclosure;

FIGS. 6A and 6B are block diagrams illustrating different steps of a camera collage editing user interaction according to an embodiment of the present disclosure; and

FIG. 7 illustrates a computing environment implementing a collage system according to an embodiment of the present disclosure.

The same reference numerals are used to represent the same elements throughout the drawings

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The various embodiments herein achieve a method and a system for creating a context based collage instantly from images using a camera. Further, the present disclosure enables assignment of the camera images belonging to the same context into a collage.

In an embodiment of the present disclosure, the term “camera” refers to any image acquisition apparatus that can generate a digital image. Many such different types of apparatuses exist, such as digital cameras, digital cameras that are built in mobile devices, Personal Digital Assistants (PDAs), laptop cameras, whether built in or external, digital cameras which are part of video cameras, and essentially any image acquisition apparatus that can perform the activities described herein.

In an embodiment of the present disclosure, it should be understood that the present disclosure is not limited to pictures of persons or, indeed, to any specific type of photographed items. For instance, a user might wish to include a number of items that are physically located apart from one another in a single photograph for a matter of convenience.

In an embodiment of the present disclosure, a collage is a way of arranging and displaying a set of images in a manner that the collage summarizes all the images in a single image. The collage is the single image created from the set of images that looks very appealing.

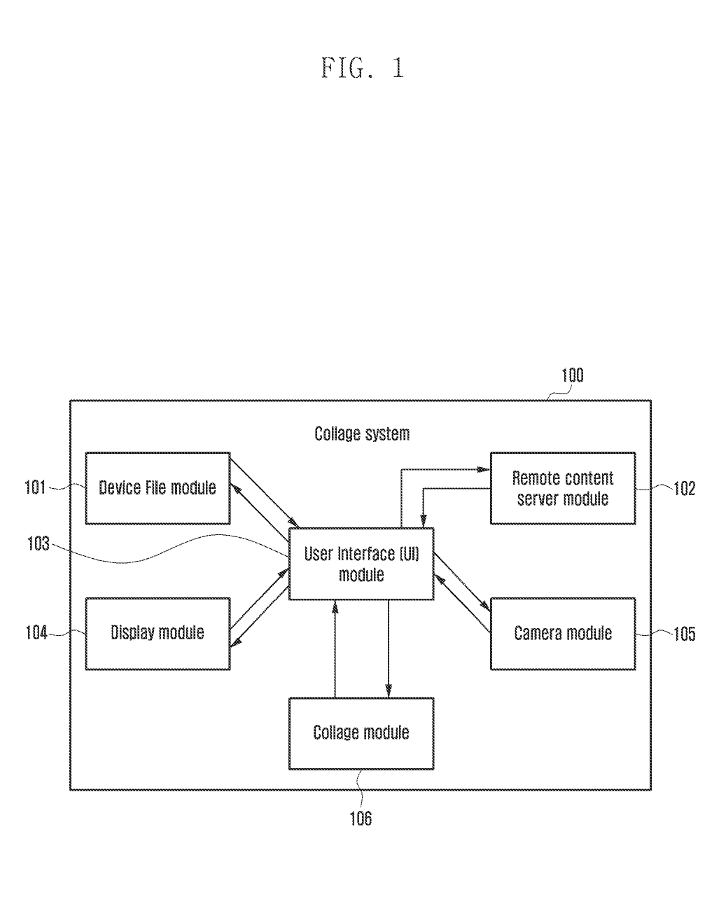

FIG. 1 illustrates a block diagram of a collage system according to an embodiment of the present disclosure.

Referring to FIG.1, a collage system 100 may include a Device File module 101, a Remote content server module 102, a User Interface (UI) module 103, a Display module 104, a camera module 105, and a collage module 106. The UI module 103 retrieves the input from the user through interfaces, such as a touch, keypad, gestures, and the like.

In an embodiment of the present disclosure, the UI module 103 may include a mouse, a keyboard, another computer, or any device or combination of devices from which data is input. The UI module 103 may also include a display device, a processor-accessible memory, or any device or combination of devices to which data is output.

The UI module 103 interfaces with the camera module 105 to obtain the captured images in real time and provides the captured images to the collage module 106 along with the configuration information, such as collage resolution, collage output file path, number of images in a collage, and the like.

In an embodiment of the present disclosure, the number of images in a collage may be decided by the user at run-time or decided automatically based on any logical criteria, such as time, context, and the like.

In an embodiment of the present disclosure, the term ‘context’ refers to an event cluster. A context corresponds to a group of digital images associated with a particular event, such as a birthday party, a holiday gathering, a vacation, and the like, which may be in sync with a particular time period or geo-location. The collage is created based on context information, such as date/time, geo-location, image content, and the like.

In an embodiment of the present disclosure, sets of images that are captured at capture locations within a distance of each other may be designated to be similar digital images. Similarly, sets of digital images that are captured within a capture time range may be designated to be in a group of similar images.

Further, the UI module 103 determines the assignment or grouping of captured images to a collage based on a plurality of parameters based on context. The parameters are as follows:

Time proximity: The images are grouped based on the timeline, such as images captured within a specific range may be grouped together.

Common Background: The images having a common background shall be grouped together. For example, a common background may be a building, a vehicle, a wall, a landscape, a texture, and the like.

Based on similar tags, such as a text, a geo-tag, an audio tag, and the like).

Based on face detection—Images of a particular person or a particular group of people may be grouped into one or multiple collages.

Based on face recognition—Images of a particular person or a particular group of person may be grouped into one or more of multiple collages.

Based on object detection, images of similar/same objects may be grouped into one or more of multiple collages.

Based on property of the image. The property may be size, resolution, quality, or any other property that may be extracted from the image.

Based on user preference.

In an embodiment of the present disclosure, if the context changes, the images belonging to the new context will be added to a new collage.

Further, the UI module 103 interacts with the display module 104 and displays the created collage(s) in one of the following methods:
A. Viewfinder along with a UI control for launching a latest collage: As soon as the user captures the new image from the camera module 105, the captured image will be inserted into the previously created collage. The created collage may be displayed by invoking a UI control. Thus, the user may continue to keep on adding the new images in the collage.
B. Real time collage frame preview along with a UI control for launching latest collage: The user will be able to see the real time preview of the new collage to be created before capturing the image. As soon as the user captures the new image from the camera module 105, that image will be inserted into the collage preview frames. Further, the collage will be updated with the new collage image and the user can review the created collage by invoking the UI control. Thus, the user may keep on adding new images in the collage.

In an embodiment of the present disclosure, a user may be able to save the created collage along with their associated captured images. The captured images may be stored either in the device file module 101 or in the remote content server module 102.

In an embodiment of the present disclosure, the collage system 100 allows the user to share the created collage by all possible image sharing features of the camera. The sharing may also be linked to a user group. For example, the group of people in a collage may be mapped to a group of users and may be directly shared to that group.

In an embodiment of the present disclosure, the UI module 103 allows the user to edit the Region of Interest (ROI). The ROI refers to the boundaries of an object which is of interest to the user while creating a collage. The editing of the ROI involves the touch event for press/release/move to decide the type of editing operation (i.e., translation, swapping, resizing, and the like) to be performed. The editing of the ROI allows the user to view the complete image upon selecting the corresponding ROI from the created collage.

In an embodiment of the present disclosure, the ROI is automatically extracted by the camera module 105.

The display module 104 provides display to the user to interact with the collage system 100 seamlessly.

In various embodiments, multiple image similarity criteria may be combined to determine the sets of similar images. For example, a context creation algorithm may be used to form clusters of digital images corresponding to different events. The images within each context cluster can be analyzed according to visual similarity to determine the sets of similar digital images.

The camera module 105 interacts with the camera device driver to provide and render the camera preview frames. Further, the camera module 105 allows the UI module 103 to capture the image in a plurality of methods described below:
1. The images may be captured through a single shot/multi shots/burst shots.
2. The images may also be captured during video recording.
3. The images may be captured in a preview mode while moving the camera module 105 continuously.
4. The images may be auto captured on features enabled on the camera module 105, such as focus, face detection/recognition, smile/blink/gesture detection, and any other logical condition matching.

In an embodiment of the present disclosure, the camera module 105 has shooting options enabled, such as a zoom, a timer, a brightness/contrast, an effect, a change of resolution, and the like).

In an embodiment of the present disclosure, the camera module 105 enables the user to switch between real time preview and collage instruction.

The images may be captured according to collage templates which may be in any shape. The user can adjust the camera viewfinder to fit the captured images into the collage template. The viewfinder electronically projects image lens on a miniature display. The image on this display is used to assist in aiming the camera module 105 at the scene to be photographed or captured.

The device file module 101 stores the collage output which may be in the form of a raw buffer or an encoded image file. Further, the constituent images forming the collage may also be saved on the device file module 101. The constituent images may also be embedded in the collage itself if needed in a smaller size.

The remote content server module 102 acts as a data storage system which includes one or more processor accessible memories configured to store information.

In an embodiment of the present disclosure, the remote content server module 102 stores the collage output which may be in the form of raw buffer or encoded image file. Further, the constituent images forming the collage may also be saved on the remote content server module 102. The constituent images may also be embedded in the collage itself if needed in a smaller size.

The display module 104 renders the camera preview frames and displays a real time indication of a progressive creation of camera collage. The created collage will be displayed in a thumbnail size window at any appropriate place on a camera preview screen. On a touch gesture at the thumbnail window, the actual created collage will be displayed.

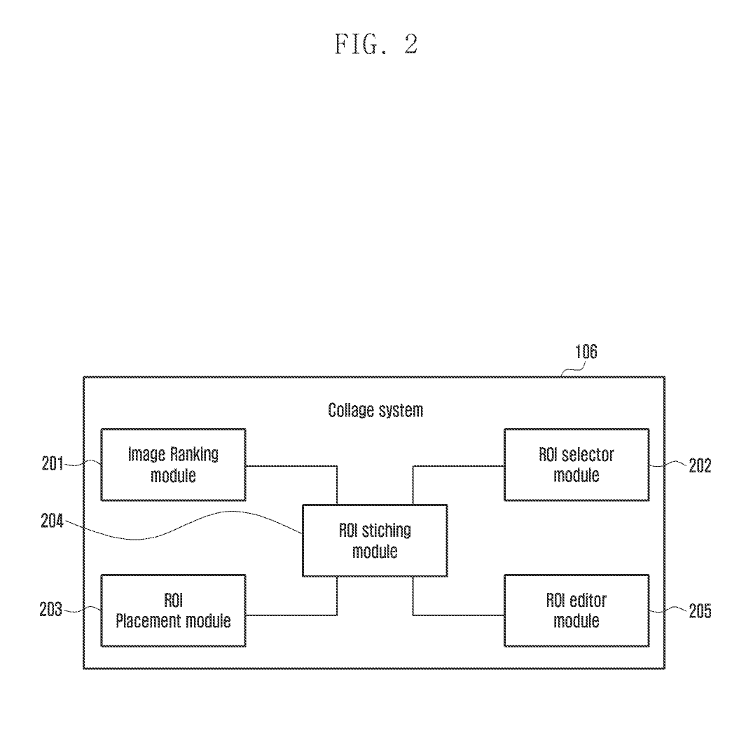

FIG. 2 is a block diagram illustrating components of a collage module according to an embodiment of the present disclosure.

Referring to FIG. 2, the collage module 106 creates a collage from a collection of images stored in the device file module 101 or the remote content server module 102. The collage module 106 also provides the position and dimensions of the ROI and the corresponding image.

Further, the collage module 106 runs as a background activity which allows the user to view the camera preview continuously. Therefore, as soon as the user captures a photo, the collage module 106 starts creating the collage in the background. The collage module 106 sends the created collage to the UI module 103 to display.

An image ranking module 201 provides a ranking score to each image based on various parameters of the image, such as an image quality (i.e., a blur, a contrast, and the like). The ranking score may be used to decide the selection of images for the collage or placement of images in the collage. For example, an image having multiple faces may be placed at the center, an image having low quality/having same person may be dropped from the collage formation. In some cases, user designated ratings may be available for some or all of the images in the image collection. For example, a user may be provided with a mechanism to tag a set of images as ‘favorites’ or to rate images using a ‘star rating’. This information may be used to provide important information about the importance of the images to the user.

An ROI selector module 202 is responsible for selection of the ROI. The ROI is considered as the most important part of the image which can describe the whole image. The ROI may be determined by using any of the ROI extraction/image segmentation algorithms or may be manually marked by the user. The selected ROI is cropped from the image and is used to form the collage.

An ROI placement module 203 places the ROIs on a rectangular canvas without any holes. The placement of the images may be based on the following parameters:
i. Order of capture
ii. Aspect ratio of ROI
iii. ROI Priority: To give a particular image more/less prominence in the collage (e.g., at the center/edge, in a larger/smaller size, in a multi/single color, and the like)

ROI relationship: According to social networking connection among the people. For example, the ROI relationship may be based on user-groups on a social network. The device user may be placed at the center and the members of the User group may be placed around the user on the collage.

An ROI stitching module 204 mainly performs the seamless blending between the ROIs provided by modules 201, 202, and 203, respectively. The ROI stitching module 204 may also protect the important portions in the ROI, such as human faces, to avoid the ghost effect.

In an embodiment of the present disclosure, the ROI stitching module 204 enables blending and smooth transition of the captured pictures in a collage, that is, there would be no image overlapping and boundary mismatch.

In an embodiment of the present disclosure, the ROI stitching module 204 may be an optional module as the camera collage may be created even without stitching ROIs, in which case, the ROI present in the collage will be placed one next to another without any overlap.

An ROI editor module 205 allows the user to edit any particular ROI present in the created collage. The following operations may be performed by the ROI editor module 205.
1. ROI swapping: The user can swap the position of ROI in the collage.
   The various approaches to trigger ROI swapping are:
   a. The user can select one ROI and drag and drop it on the other ROI. Thus, the selected ROI will be swapped with the ROI present at the dropped location.
   b. The user can select two ROIs using multi-point touch and move the two fingers towards each other.
2. ROI resizing: The user can change the size of the ROIs placed in the collage. There are two kinds of ROI resizing:
   a. ROI zooming: Resize the size with respect to a corresponding image. In this method, the ROI will get zoomed-in or zoomed-out by an amount determined based on user interaction. The size of the other ROI will not be affected. In an embodiment of the present disclosure, the user interaction may be one or more touch events.
b. ROI resize: In this method, the ROI gets zoomed in or zoomed out by an amount determined based on user interaction. The size of the other ROIs will change based on the amount of resizing of a selected ROI.
3. ROI content translation: The user can shift the position of ROI in the collage with respect to the image associated with the ROI. The amount of shifting in the x or y direction is calculated based on the touch move event received from the user interface and collage resolution. ROI translation will be limited within its corresponding image boundary.
4. ROI deletion/addition: The user can delete any ROI from the created collage. The image to be deleted is selected using the user interaction. In an embodiment of the present disclosure, the user interaction may be a touch event, selecting an option from a menu, and the like. If the user touch-hold and drag the image beyond the collage boundary, the selected ROI shall be deleted from the collage. To add an image, the user can import any image from the gallery. All the remaining ROIs shall be readjusted on the collage.
5. ROI effect: The user can apply various image effects on a selected ROI.

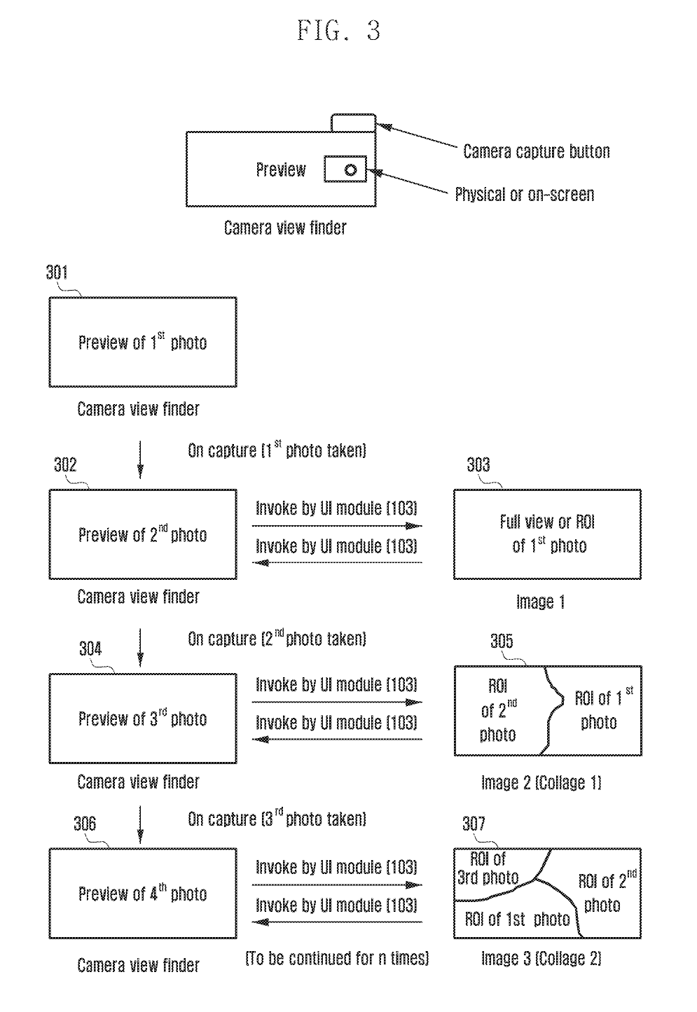

FIG. 3 is a block diagram illustrating a camera collage user interaction according to an embodiment of the present disclosure.

Referring to FIG. 3, the preview of the viewfinder may be displayed on the display module 104. As soon as the user captures the new image from the camera module 105, the captured image will be inserted into the previously created collage. The created collage may be seen by invoking the UI module 103, which may be any trigger, such as a button, a gesture based, and the like. Thus, the user may keep on adding the new images in the collage.

At operation 301, the user sees the preview of 1^{st} captured photo, further the user may capture another photo and at operation 302 the display module 104 displays the preview of 2^{nd} photo. The UI module 103 is invoked which results in displaying the full view or ROI of the 1^{st} photo, at operation 303, which is the 1^{st} image in the resulting collage. Further, at operation 304, the preview of 3^{rd} photo is displayed by the display module 104. The UI module 103 is invoked and at operation 305, the UI module 103 displays the ROI of 2^{nd} photo and the ROI of 1^{st} photo which is the second image in the resulting collage.

At operation 306, the preview of 4^{th} photo is displayed by the display module 104. The UI module 103 is invoked which results in displaying image 3 is the ROI of 3^{rd} photo, ROI of 2^{nd} photo, and the ROI of 1^{st} photo, at operation 307, which is the third image in the resulting collage. This process of adding images may be repeated for n number of times. It will be apparent to a person of ordinary skill in the art, that though the process of adding images in the collage may be repeated for n number of times, the process may depend on extraneous factors, such as the camera module 105 capabilities, the amount of storage in the camera module 105, and the like.

In an embodiment of the present disclosure, the method further includes the operation of using one or more of the selected important images to create a photographic product, such as a digital slide show, a photo album, a photo calendar, a photo collage, and the like. A digital slide may be presented on a digital picture frame, a living room entertainment device, a photo sharing website, and the like. A photo album may be a printed album, a soft copy album, and the like.

In another embodiment of the present disclosure, the method further includes the operation of sharing the selected important images on a social networking website or a photo-sharing website.

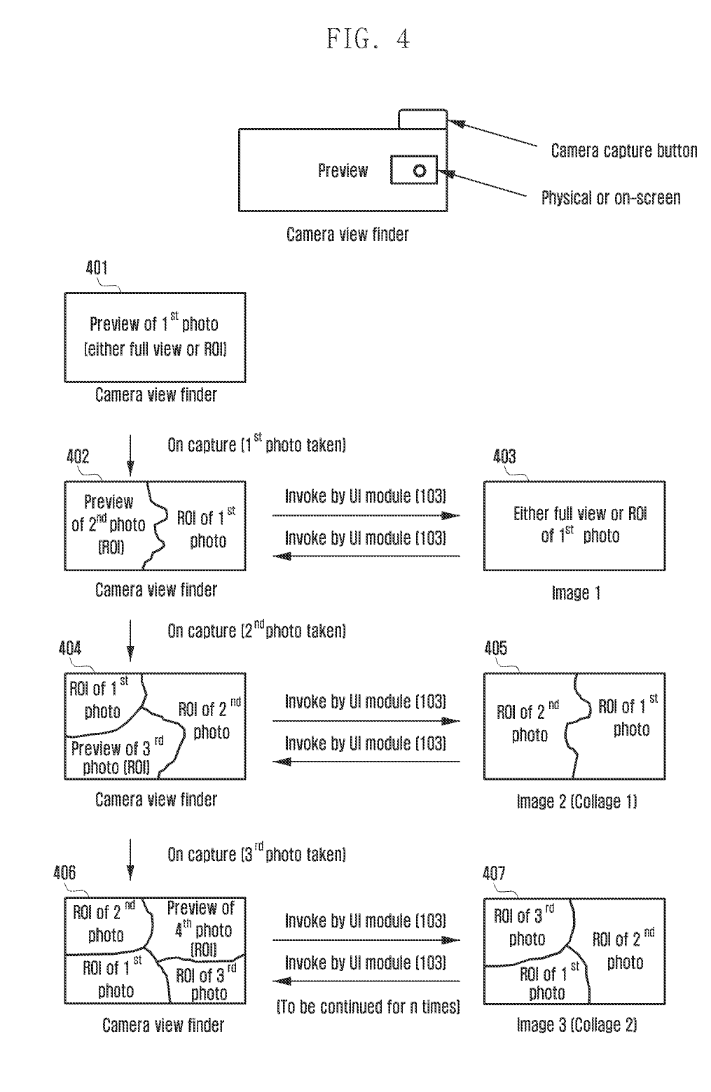

FIG. 4 is a block diagram illustrating a real time collage frame preview along with a latest collage according to an embodiment of the present disclosure.

Referring to FIG. 4, the preview of real time created collages may be seen by inserting the camera preview frames in the previously created collage frame. The user will be able to see the real time preview of the new collage to be created before capturing the image. As soon as the user captures the new image from the camera, that image will be inserted into the collage preview frames and also the collage will be updated with the new collage image. The user may review the created collage by invoking the UI control. The UI control may be any trigger, such as a button, a gesture based, and the like. Thus, the user may keep on adding the new images in the collage.

At operation 401, the preview of 1^{st} photo may be displayed by the display module 104 once the 1^{st} photo taken is captured. At operation 402, the preview of 2^{nd} photo ROI and the ROI of 1^{st} photo are displayed by the display module 104. The UI module 103 is invoked at operation 403, either the full view or ROI of 1^{st} photo which results in image 1 of the resulting collage.

At operation 404, the ROI of 1^{st} photo, ROI of 2^{nd} photo, and the preview of 3^{rd} photo ROI are displayed by the display module 104. The UI module 103 is invoked and at operation 405, the ROI of 2^{nd} photo and the ROI of 1^{st} photo are displayed. This results in image 2 of the collage. At operation 406, the ROI of 2^{nd} photo, the preview of 4^{th} photo ROI, the ROI of 1^{st} photo, and the ROI of 2^{nd} photo are displayed by the display module 104. The UI module 103 is invoked and at operation 407, the ROI of 3^{rd} photo, ROI of 1^{st} photo, and ROI of 2^{nd} photo results in image 3 of the resulting collage. This process may be repeated for n number of times.

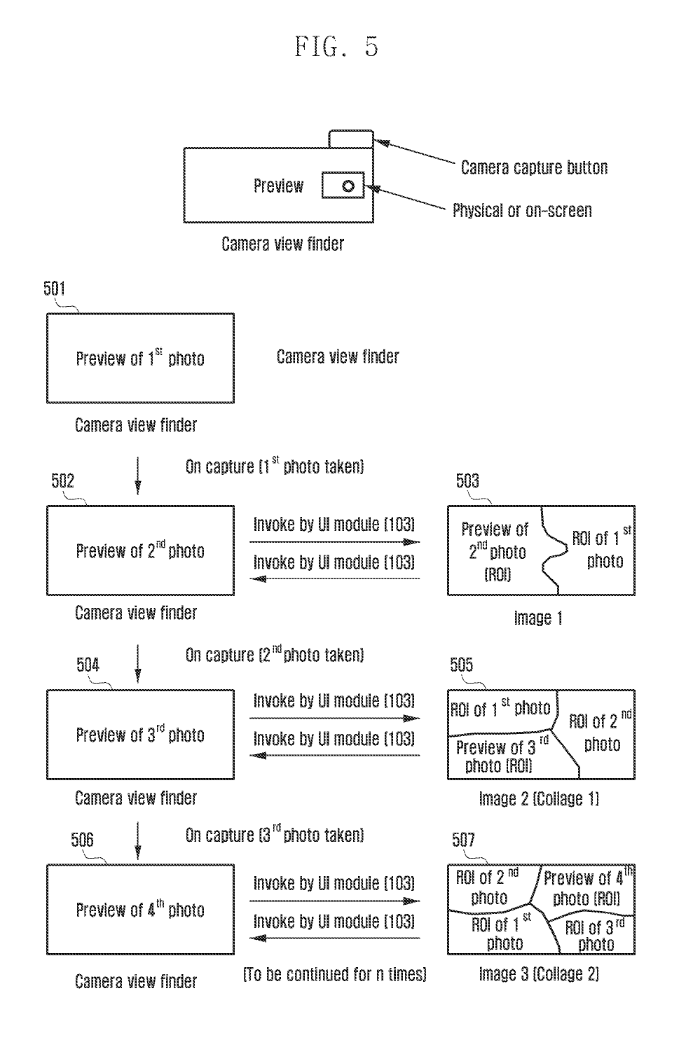

FIG. 5 is a block diagram illustrating a viewfinder along with a real time collage frame preview according to an embodiment of the present disclosure.

Referring to FIG. 5, the preview of the viewfinder is displayed by the display module 104. The user may capture the images to be inserted to a collage and the user will be able to view a real time collage preview by invoking the UI module 103. The UI module 103 may be any trigger, such as a button, a gesture based, and the like. Thus, the user may keep on adding new images in the collage.

At operation 501, the preview of 1^{st} photo is displayed by the display module 104 and at operation 502 the preview of 2^{nd} photo is displayed which is invoked by the UI module 103 and at operation 503, the preview of 2^{nd} photo ROI and the ROI of 1^{st} photo are displayed.

At operation 504, the preview of 3^{rd} photo is displayed which is invoked by the UI module 103 and at operation 505 the ROI of 1^{st} photo, the preview of 3^{rd} photo ROI, and the ROI of 2^{nd} photo are displayed. At operation 506, the preview of 4^{th} photo is displayed which is invoked by the UI module 103 and at operation 507, the ROI of 2^{nd} photo, preview of 4^{th} photo ROI, ROI of 1^{st} photo, and the ROI of 3^{rd} photo are displayed. This process may be continued for n number of times.

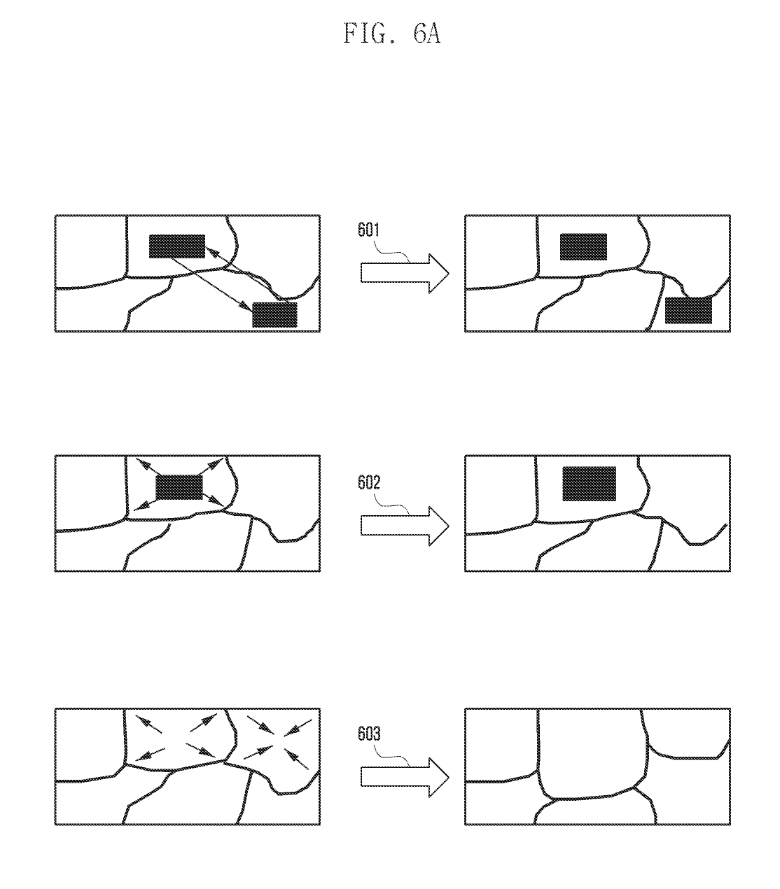

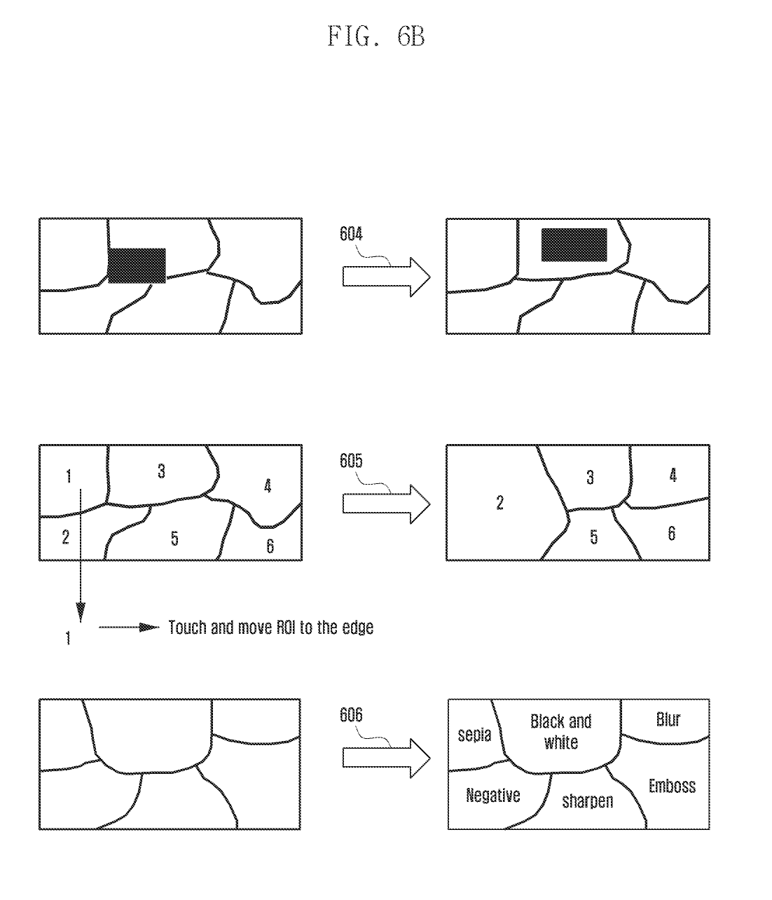

FIGS. 6Aand 6B are block diagrams illustrating different steps of camera collage editing user interaction according to an embodiment of the present disclosure. The user may view the complete image upon selecting the corresponding ROI from the created collage.

Referring to FIGS. 6A and 6B, initially at operation 601 ROIs may be swapped in a collage, at operation 602, the contents of an ROI may be zoomed.

In an embodiment of the present disclosure, the ROI in a collage when invoked by the UI module 103, the entire photo may be displayed.

Further, at operation 603, the ROI may be resized to an appropriate dimension as requested by the user. The resizing may include cropping, stretching, and the like. At operation 604, the contents of an ROI may also be translated and at operation 605, the user may choose to delete an ROI or a plurality of ROIs from the collage. At operation 606, certain effects, such as coloring, shading, blurring, sharpening, embossing, and the like, may be applied.

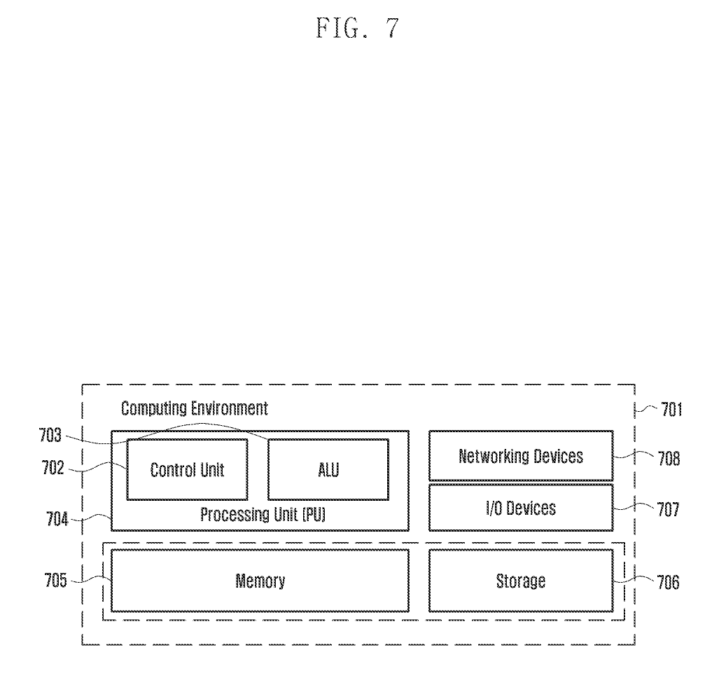

FIG. 7 illustrates a computing environment implementing a collage system according to an embodiment of the present disclosure.

Referring to FIG. 7, a computing environment 701 may include at least one processing unit 704 that is equipped with a control unit 702 and an Arithmetic Logic Unit (ALU) 703, a memory 705, a storage unit 706, a plurality of networking devices 708, and a plurality Input Output (I/O) devices 707. The processing unit 704 is responsible for processing the instructions of the algorithm. The processing unit 704 receives commands from the control unit in order to perform processing. Further, any logical and arithmetic operations involved in the execution of the instructions are computed with the help of the ALU 703.

The overall computing environment 701 may include multiple homogeneous and/or heterogeneous cores, multiple Central Processing Units (CPUs) of different kinds, special media, and other accelerators. The processing unit 704 is responsible for processing the instructions of the algorithm. Further, the plurality of processing units 704 may be located on a single chip or over multiple chips.

The algorithm including instructions and codes used for the implementation are stored in either the memory unit 705, the storage 706, or both. At the time of execution, the instructions may be fetched from the corresponding memory 705 and/or storage 706, and executed by the processing unit 704.

In a case of any hardware implementations various networking devices 708 or external I/O devices 707 may be connected to the computing environment to support the implementation through the networking unit and the I/O device unit

The various embodiments disclosed herein may be implemented through at least one software program running on at least one hardware device and performing network management functions to control the elements. The elements shown in FIGS. 1, 2, and 7 include blocks which may be at least one of a hardware device, or a combination of hardware device and software module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for creating a context based collage dynamically while capturing images in a camera, the method comprising:
selecting the images to create the collage by a user;
invoking a User Interface (UI) to obtain an input from the user;
extracting a Region of Interest (ROI) for the images; and
creating the collage using the images based on a context criterion.

2. The method of claim 1, further comprising obtaining the input from the user, wherein the input comprises at least one of a touch input, a keypad input, and a gesture interface input.

3. The method of claim 1, wherein the context criterion comprises at least one of a time, a geo-location, and an image content.

4. The method of claim 3, wherein, if the context changes, the image collage belonging to a new context will be added to a new collage.

5. The method of claim 3, wherein the creating of the collage comprises grouping the images to create the collage based on parameters, wherein the parameters comprise at least one of a time proximity, a common background, a similar tag, a face detection, a face recognition, an object detection, a property of the image, and a user preference.

6. A system for creating a context based collage dynamically while capturing images in a camera, the system comprising:
a device file module, a remote content server module, a User Interface (UI) module, a display module, a camera module, a collage module, and an integrated circuit comprising at least one processor, and
at least one memory having a computer program code within the integrated circuit,
wherein the at least one memory and the computer program code along with the at least one processor cause the system to:
select the images to create the collage by a user using the UI module;
invoke an UI to obtain an input from the user using the UI module;
extract a Region of Interest (ROI) for the images using the camera module; and
create the collage using the collage module based on a context criterion.

7. The system of claim 6, wherein the UI module is configured to interface with the camera module to obtain the captured image dynamically.

8. The system of claim 6, wherein the collage module further comprises at least one of an image ranking module, an ROI stitching module, an ROI selector module, an ROI placement module, and an ROI editor module.

9. The system of claim 6, wherein the remote content server module is configured to store the collage.

10. The system of claim 6, wherein the user interface module is configured to group the images to create the collage based on parameters, wherein the parameters comprise at least one of a time proximity, a common background, a similar tag, a face detection, a face recognition, an object detection, a property of the image, and a user preference.

11. The system of claim 6, wherein the user interface module is configured to interact with the display module to display the created collage by using at least one of capturing real time collage frame preview along with the UI module for launching the collage, using viewfinder along with the UI module for launching the collage, and using the viewfinder along with the UI module for launching real time collage frame preview.

12. The system of claim 6, wherein the user interface module is configured to allow the user a view of the collage upon selecting the corresponding ROI.

13. The system of claim 6, wherein the display module is configured to display a real time indication of progressive creation of the collage.

14. The system of claim 8, where the image ranking module is configured to provide a ranking score based on parameters, wherein the parameters comprise at least one of an image quality, and objects present in the images.

15. The system of claim 8, wherein the ROI selector module is configured to allow the user to select the ROI and the ROI placement module is configured to place the ROI on a rectangular canvas.

16. The system of claim 8, wherein the ROI placement module is configured to place the ROI based on parameters, wherein the parameters comprise at least one of an order of capture, an aspect ratio of the ROI, an ROI priority, and an ROI relationship.

17. The system of claim 8, wherein the ROI stitching module is configured to perform seamless blends between the ROI and the ROI editor module is configured to allow the user to edit any particular ROI.

18. The system of claim 17, wherein the ROI editor module is configured to perform at least one of an ROI swapping and an ROI resizing.

19. The system of claim 6, wherein the system is configured to obtain the input from the user, wherein the input comprises at least one of a touch input, a keypad input, and a gesture interface input.

20. A device for creating a context based collage dynamically while capturing images in a camera, the device comprising:
an integrated circuit comprising at least one processor; and
at least one memory having a computer program code within the integrated circuit,
wherein the at least one memory and the computer program code with the at least one processor cause the device to:
select the images to create the collage by a user;
invoke a User Interface (UI) to obtain an input from the user;
extract Region of Interest (ROI) for the images; and
create the collage based on a context criterion.
